(19) United States
(12) Patent Application Publication
(10) Pub. No.: US 2008/0087647 A1
(43) Pub. Date: Apr. 17, 2008

(54) Self-Adhesive Elastomer Layer In Circuit-Breaker Poles Insulated By Solid Material

(75) Inventor: Ralf-Reiner Volkmar, Oldenburg i. H. (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT

(21) Appl. No.: 11/663,901

(22) PCT Filed: Sep. 13, 2005
(86) PCT No.: PCT/EP05/54543

§ 371 Date: Mar. 26, 2007

(30) Foreign Application Priority Data
Sep. 24, 2004 (DE) 10-2004-047.276.9

(51) Int. Cl. H01H 33/66

(52) U.S. Cl. 218/134

(57) ABSTRACT

A circuit-breaker pole insulated by solid material, with an electrically non-conductive and dimensionally stable insulating material housing. An interrupter is disposed in the housing. The interrupter has a fixed contact and a moving contact, which is located opposite the fixed contact on a drive side and is guided in a longitudinally movable manner. The insulating material housing is open on the drive side in order to allow the introduction of a drive movement into the moving contact. An elastic padding is arranged between the interrupter and the insulating material housing. The elastic padding has such self-adhesive properties that an adhesive bond that can only be abrasively released is obtained both with the interrupter and with the insulating material housing.

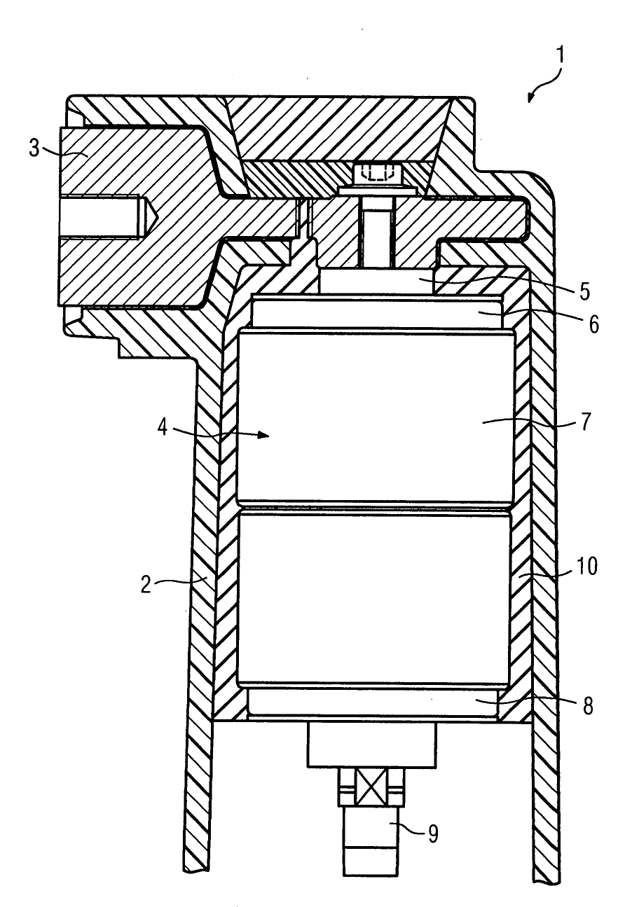

Self-adhesive elastomer layer in circuit-breaker poles insulated by solid material

The invention relates to a circuit-breaker pole insulated by solid material, with an electrically non-conductive and dimensionally stable insulating material housing, arranged in which is an interrupter, which has a fixed contact and a moving contact, which is located opposite the fixed contact on the drive side and is guided in a longitudinally movable manner, the insulating material housing being open on the drive side in order to allow the introduction of a drive movement into the moving contact, and an elastic padding being arranged between the interrupter and the insulating material housing.

Such a circuit-breaker pole is already known from EP 0866481 A2. The circuit-breaker pole disclosed there has a rigid, or in other words dimensionally stable, insulating material housing, in which a vacuum interrupter is fixed. The vacuum interrupter has a stationary fixed contact, which is fixedly connected to a connection piece led out from the insulating material housing. Arranged opposite the fixed contact is a moving contact, which is guided in a longitudinally movable manner with respect to the fixed contact. In this case, the fixed contact and the moving contact protrude into the interior of the vacuum interrupter. In the vacuum interrupter there is a vacuum, which helps to quench an arc that forms between the contacts when they open. In order to allow the introduction of a drive movement into the moving contact, the insulating material housing has on the drive side an inlet opening, through which there extends an operating rod, which is connected to a drive unit by means of an expedient lever mechanism. The moving contact is connected by means of a flexible strip conductor to a second connection piece, which is likewise led out from the insulating material housing and can consequently be contacted from the outside. In the switched-on state, the moving contact lies against the fixed contact, so that a conducting connection is established between the connection pieces led out from the insulating material housing. To interrupt the current flow, the contacts are separated from each other by introducing a drive movement, the arc being quenched when the current of the vacuum interrupter passes through zero.

In order to avoid air inclusions, and consequently high voltage peaks, an elastic padding of ethylene propylene, rubber, silicone or silicone rubber is provided between the vacuum interrupter and the dimensionally stable insulating material housing. The elastic padding compensates for different thermal coefficients of the vacuum chamber and thereby prevents cracks from forming in the rigid insulating material housing. To produce the circuit-breaker pole insulated by solid material, the elastic padding is slipped over the vacuum interrupter as a shrink-fit tube. Subsequently, the vacuum interrupter is cast into the insulating material housing by a casting-shaping method.

The already known circuit-breaker pole insulated by solid material has the disadvantage that air inclusions can occur in spite of the elastic padding. On account of the voltage peaks thereby produced, in particular at relatively high voltages, there is the risk of leakage currents or partial discharges.

A high-power bushing with an encapsulated vacuum interrupter is known from DE 22 40 106. In this case, the vacuum interrupter is completely embedded in the insulating body of the bushing. In order to avoid the formation of cracks due to thermal expansion, an elastic pad is provided between the dimensionally stable insulating body and the vacuum interrupter. To produce the bushing, the vacuum interrupter is coated with a layer of an elastic material, which is for example a cementing or adhesive material. Subsequently, the epoxy resin of the insulating material housing is molded around the vacuum interrupter. The elastic padding disclosed there is flexible and adheres both to the vacuum interrupter and to the encapsulating insulating material housing. On account of the production method, the thickness of the elastic padding is between 1 mm and approximately 6 mm. Polyurethanes and polysulfides are specified as the material for the elastic padding.

The object of the invention is to provide a circuit-breaker pole insulated by solid material of the type mentioned at the beginning which can be easily produced and in which air inclusions between the interrupter and the insulating material housing are avoided.

The invention achieves this object by the elastic padding having such self-adhesive properties that an adhesive bond that can only be abrasively released is obtained both with the interrupter and with the insulating material housing.

According to the invention, the elastic padding consists of a self-adhesive material which develops such a high surface adhesion on the dimensionally stable insulating housing on the one hand and the housing of the interrupter on the other hand that the occurrence of air inclusions between the insulating material housing and the interrupter is avoided, even over relatively long periods in operation. On account of the great adhesive effect, dependable securement of the interrupter in the insulating material housing is obtained. For this reason, it is possible to dimension the insulating material housing in such a way as to allow retrofitting of the interrupter into the insulating material housing. It is therefore possible according to the invention to produce the insulating material housing and the vacuum interrupter independently of each other, subsequently fix the vacuum interrupter in the insulating material housing and finally surround it with the elastic padding, which allows fixed and at the same time elastic securement of the vacuum interrupter. The term abrasive is to be understood within the scope of the invention as meaning that the surface adhesion of the elastic padding both to the interrupter and to the insulating material housing is greater than the tear resistance and/or tear propagation resistance of the elastic padding.

The self-adhesion of the elastic padding is advantageously also provided on untreated surfaces. Consequently, the invention dispenses with the need for the laborious use of a surface treatment with primers or the like to provide the self-adhesive effect, whereby the production costs can be lowered still further.

The elastic padding expediently has a dielectric strength of at least 20 kV/mm. This high dielectric strength has the effect of providing a compact construction of the circuit-breaker pole insulated by solid material according to the invention.

The hardness of the elastic padding expediently has a Shore 00 or Shore A value that lies between 30 and 40.

The elongation at break expediently lies between 120 and 500%. The elastic padding is advantageously pore-free. The absence of pores has the effect of avoiding voltage peaks.

The interrupter is advantageously a vacuum interrupter, which for example comprises a cylindrical ceramic housing which is covered at the ends by two metal caps. The metal caps are respectively penetrated by contact rods bearing contact pieces, a fixed contact being fixedly connected to the metal cap that is assigned to it. The moving contact, lying opposite the fixed contact in the longitudinal direction, is connected to one end cap by means of a metal bellows, so that said moving contact is guided in a longitudinally movable manner with respect to the fixed contact. The moving contact is connected by means of partly insulating operating rods and by means of a lever mechanism to a drive unit, the drive movement of which is introduced into the moving contact.

The dimensionally stable insulating material housing consists for example of cast resin.

Other expedient refinements and advantages of the invention are the subject of the following description of exemplary embodiments of the invention with respect to the figure of the drawing,

the figure showing an exemplary embodiment of a circuit-breaker pole insulated by solid material according to the invention, in a sectioned side view.

The figure shows an exemplary embodiment of a circuit-breaker pole 1 insulated by solid material according to the invention in a cross-sectional view. The circuit-breaker pole 1 insulated by solid material is intended for interrupting the current flow in a phase of a three-phase network. Since customary three-phase networks have three phases, in commercially available circuit breakers there are usually three circuit-breaker poles 1 insulated by solid material that are set up next to one another and are connected to a common drive unit.

The circuit-breaker pole 1 insulated by solid material that is shown has an insulating material housing 2 that is formed from epoxy resin, or in other words casting resin, in which an upper connection piece 3 and a middle connection piece (not represented in the figure) are fixed. In the insulating material housing 2 there can also be seen a vacuum interrupter 4, which is rigidly connected to the connection piece 3 by means of a fixed contact rod 5. The fixed contact rod 5 passes through an end cap 6 consisting of copper, it bearing a fixed contact (not represented in the figure) at its end that is arranged in the interior of the vacuum interrupter 4. The end cap 6 is connected in a vacuum-tight manner to a hollow-cylindrical vacuum housing 7, which consists of ceramic and has on its side opposite from the first end cap 6 a second end cap 8, which in turn is passed through by a moving contact rod 9. The moving contact rod 9 bears at its end protruding into the vacuum interrupter 4 a moving contact, which lies opposite the fixed contact and comes into contact with the fixed contact by introducing a drive movement by means of an operating rod (not represented in the figure).

For the longitudinally movable guidance of the moving contact, a bellows (likewise not represented in the figure) is provided and is connected in a vacuum-tight manner by its one end to the end cap 8 and by its other end to the moving contact.

In the interior of the vacuum housing comprising the end caps 6 and 8 and also the ceramic housing 7 there is a vacuum, which helps to quench an arc that forms when the contacts separate and an AC current passes through zero. The moving contact rod 9 is electrically connected to the second contact piece by means of a conductor strip (not represented in the figure), so that in a contact position the current is allowed to flow between the connection piece 3 and the second connection piece.

On account of different coefficients of thermal expansion, different thermal expansions of the components of the vacuum interrupter 4 occur when there are changes in temperature. In order to avoid air inclusions, an elastic padding 10 is therefore provided between the vacuum interrupter 4 and the insulating material housing 2. The elastic padding 10 has such high self-adhesive forces that it fixedly connects the vacuum interrupter 4 to the insulating material housing 2. In this case, the elastic padding has an elongation at break of approximately 200% and a high dielectric strength, so that the necessary dielectric strength of the vacuum interrupter 4 is provided. On account of the great self-adhesion, the occurrence of air inclusions is avoided, even over relatively long periods in operation under adverse environmental conditions.

In this case, the elastic padding has a thickness of between approximately 0.3 cm and 3 cm, so as to allow easy fitting of the vacuum interrupter into the dimensionally stable insulating material housing 2. For example, it is possible according to the invention to form the insulating material housing 2 by the shaping-casting method. Subsequently, the connection piece 3 is screwed to the fixed contact rod 4 and the elastic padding 10 is introduced by filling.

1-6. (canceled)

7. A circuit-breaker pole insulated by solid material, comprising:
an electrically non-conductive and dimensionally stable insulating material housing;
an interrupter disposed in said insulating material housing, said interrupter including a fixed contact and a moving contact opposite said fixed contact, said moving contact being longitudinally movable in said insulating material housing on a drive side of said interrupter;
said insulating material housing being open on the drive side for introduction a drive movement into said moving contact; and
an elastic padding disposed between said interrupter and said insulating material housing, said elastic padding having such self-adhesive properties that an adhesive bond that can only be abrasively released is obtained both with said interrupter and with said insulating material housing.

8. The circuit-breaker pole according to claim 7, wherein said elastic padding develops the self-adhesive properties even on untreated surfaces.

9. The circuit-breaker pole according to claim 7, wherein said elastic padding has a dielectric strength of at least 20 kV/mm.

10. The circuit-breaker pole according to claim 7, wherein said elastic. padding has a low hardness with a Shore 00 or Shore A value between 30 and 40.

11. The circuit-breaker pole according to claim 7, wherein said elastic padding has an elongation at break of between 120 and 400%.

12. The circuit-breaker pole according to claim 7, wherein said elastic padding is a substantially pore-free padding.
